(19) United States
(12) Patent Application Publication
(10) Pub. No.: US 2026/0353300 A1
(43) Pub. Date: Nov. 5, 2026

(54) CELLULAR DOWNLINK TRANSMISSION POWER CONTROL

(71) Applicant: Telefonaktiebolaget LM Ericsson (publ), Stockholm (SE)

(72) Inventor: Chi Chuen YUEN, Solna (SE)

(21) Appl. No.: 19/108,044

(22) PCT Filed: Aug. 31, 2022
(86) PCT No.: PCT/EP2022/074200

§ 371 Date: Feb. 28, 2025

(51) Int. Cl. H04W 52/14

(52) U.S. Cl. CPC H04W 52/143

(57) ABSTRACT

A method (100) of downlink transmission power control is presented. The method (100) is performed by a network node in communication with two or more wireless devices. The method (100) comprises, repeatedly transmitting (110) transmissions at a common transmission power on a shared wireless channel to each of the two or more wireless devices. The method 100 further comprises obtaining (120) a reception indicator indicative of an ability of the two or more wireless devices to successfully receive the respective transmissions, determining (130) an updated common transmission power based on the reception indicator, and providing (140) the updated common transmission power for use as the common transmission power for subsequent transmissions on the shared wireless channel.

### TECHNICAL FIELD

The present disclosure relates to a method of downlink transmission power control, and more precisely to a method of downlink transmission power control in a shared wireless channel.

### BACKGROUND

Current wireless communication networks may be configured in numerous different ways. One common configuration is that utilized by cellular networks where a common network node is in communication with a plurality on wireless devices. Such one-to-many architecture may be implemented using various techniques for spectrum access, but a common approach is to utilize a channelized system where some, or all, channels are shared between the plurality of devices connected to the base station.

Generally, the wireless devices are battery powered portable wireless devices, and their power consumption has been the main focus when power consumption is optimized in a cellular network. However, it is the network node that is the single device that consumes the most power of the devices in the one-to-many architecture.

Further to this, if two or more network nodes are deployed adjacently, they will inevitable interfere at a wireless device operating at the edge between the network nodes.

From the above it is understood that there is room for improvements.

### SUMMARY

It is in view of the above considerations and others that the various embodiments of this disclosure have been made. The present disclosure therefor recognizes the fact that there is a need for alternatives to (e.g. improvement of) the existing art described above.

It is an object of some embodiments to solve, mitigate, alleviate, or eliminate at least some of the above or other disadvantages.

An object of the present disclosure is to provide a new type of downlink transmission power control performed by a network node which is improved over prior art and which eliminates or at least mitigates the drawbacks discussed above. More specifically, an object of the invention is to provide a downlink transmission power control performed by a network node that is efficient and does not require expensive and complex hardware for gain and power control. These objects are achieved by the technique set forth in the appended independent claims with preferred embodiments defined in the dependent claims related thereto.

In a first aspect, a method of downlink transmission power control performed by a network node is presented. The network node is in communication with one or more wireless devices. Preferably two or more wireless devices. The method comprises repeatedly transmitting transmissions at a common transmission power on a shared wireless channel to each of the one or more wireless devices. The method further comprises obtaining a reception indicator indicative of an ability of the one or more wireless devices to successfully receive the respective transmissions, determining an updated common transmission power based on the reception indicator and providing the updated common transmission power for use as the common transmission power for subsequent transmissions on the shared wireless channel.

In one variant, determining an updated common transmission power is further based on a utilization of the shared wireless channel. This is beneficial as the utilization is, in addition to the reception indicator, provides further data as to how to accurately determine the updated common transmission power.

In one variant, determining an updated common transmission power is based on a data structure mapping the utilization of the shared wireless channel to an action space comprising a plurality of transmission quality indicators. Each of the transmission quality indicators of the plurality of transmission quality indicators is associated with a transmission power indicator. This is beneficial as it simplifies the determining the updated common transmission power and thereby reducing computational resources required when determining the updated common transmission power.

In one variant, the transmission quality indicators of the data structure each comprises a Q-value and an associated probability. Both the Q-value and the associated probability are associated with a respective transmission power indicator. This is beneficial as it provides the opportunity to estimate the probability of successful transmissions when the respective transmission power indicator is used.

In one variant, the method further comprises determining the action space associated with the utilization of the shared wireless channel, determining the transmission quality indicator associated with the transmission power indicator of the determined action space matching the common transmission power, and further updating the determined transmission quality indicator based on the obtained reception indicator. This is beneficial as the action space will be updated, compensated and refined based on the obtained reception indicator.

In one variant, determining an updated common transmission power is performed by means of a neural network.

In one variant, the neural network is based on a configurable reward function configured to determine a reward based on the reception indicator and a reward threshold.

In one variant, the shared wireless channel is a Physical Downlink Shared Channel, PDSCH.

In one variant, the reception indicator is based on Hybrid Automatic Repeat Requests, HARQs, obtained from the two or more wireless devices.

In one variant, providing the updated common transmission power further comprises providing the updated common transmission power for use as a common transmission power for transmissions on one or more additional wireless channels. This is beneficial as it provides further modes of energy conservation and enables the network node to further control and potentially reduce transmission power on more channels.

In one variant, the method is repeated at a period time that is a multiple of a slot period of the shared wireless channel.

In one variant, the communication between the network node and the two or more wireless devices is interference limited. In interference limited environments, it is less likely than in coverage limited environments, that a reduction of transmission power will reduce signal quality.

In a second aspect, a data processing unit is presented. The data processing unit is configured to be operatively connected to a network node in communication with one or more wireless devices, preferably two or more wireless devices. The data processing unit is configured to control a downlink transmission power of the network node by repeatedly causing transmitting of transmissions at a common transmission power on a shared wireless channel to each of the two or more wireless devices. The data processing unit is further configured to cause obtaining of a reception indicator indicative of an ability of the two or more wireless devices to successfully receive the respective transmissions, determining of an updated common transmission power based on the reception indicator and further provisioning of the updated common transmission power for use as the common transmission power for subsequent transmissions on the shared wireless channel.

In one variant, causing the determining of an updated common transmission power is further based on a utilization of the shared wireless channel. This is beneficial as the utilization is, in addition to the reception indicator, provides further data as to how to accurately determine the updated common transmission power.

In one variant, causing the determining of an updated common transmission power is based on a data structure mapping the utilization of the shared wireless channel to an action space comprising a plurality of transmission quality indicators. Each of the transmission quality indicators of the plurality of transmission quality indicators is associated with a transmission power indicator. This is beneficial as it simplifies the determining the updated common transmission power and thereby reducing computational resources required when determining the updated common transmission power.

In one variant, the transmission quality indicators of the data structure each comprises a Q-value and an associated probability, both associated with the respective transmission power indicator. This is beneficial as it provides the opportunity to estimate the probability of successful transmissions when the respective transmission power indicator is used.

In one variant, the data processing unit is further configured to cause determining of the action space associated with the utilization of the shared wireless channel, determining of the transmission quality indicator associated with the transmission power indicator of the determined action space matching the common transmission power on a shared wireless channel, and updating of the determined transmission quality indicator based on the obtained reception indicator. This is beneficial as the action space will be updated, compensated and refined based on the obtained reception indicator.

In one variant, causing determining of an updated common transmission power is performed by means of a neural network.

In one variant, the neural network is based on a configurable reward function configured to determine a reward based on the reception indicator and a reward threshold.

In one variant, the shared wireless channel is a Physical Downlink Shared Channel, PDSCH.

In one variant, the reception indicator is based on Hybrid Automatic Repeat Requests, HARQs, obtained from the two or more wireless devices.

In one variant, causing the provisioning of the updated common transmission power further comprises causing provisioning of the updated common transmission power for use as a common transmission power for transmissions on one or more additional wireless channels. This is beneficial as it provides further modes of energy conservation and enables the network node to further control and potentially reduce transmission power on more channels.

In one variant, the data processing unit is configured to cause control of the downlink transmission power of the network node repeatedly at a period time that is a multiple of a slot period of the shared wireless channel.

In variant, the communication between the network node and the two or more wireless devices is interference limited. In interference limited environments, it is less likely than in coverage limited environments, that a reduction of transmission power will reduce signal quality.

In a third aspect, a network node comprising the data processing unit of the second aspect is presented.

In a fourth aspect, a wireless network is presented. The wireless network comprises at least one network node in communication with two or more wireless devices and a data processing unit according to the second aspect that is operatively connected to the at least one network node.

In a fifth aspect, a data processing unit operatively connected to a network node is presented. The data processing unit is configured to perform the method of the first aspect.

In a sixth aspect, a network node comprising the data processing unit of the fifth aspect is presented.

In a seventh aspect, a computer program product comprising a non-transitory computer readable medium is presented. The computer program product has thereon a computer program comprising program instructions. The computer program is loadable into a data processing unit and configured to cause execution of the method according to the first aspect when the computer program is run by the data processing unit.

### BRIEF DESCRIPTION OF THE DRAWINGS

These and other aspects, features and advantages will be apparent and elucidated from the following description of various embodiments; references being made to the appended diagrammatical drawings which illustrate non-limiting examples of how the concept can be reduced into practice.

FIG. 1 is a schematic view of a wireless network according to some embodiments of the present disclosure,

FIG. 2 is a schematic view of a shared wireless channel according to the prior art,

FIG. 3 is a schematic view of a shared wireless channel according to some embodiments of the present disclosure,

FIG. 4 is a signaling scenario according to some embodiments of the present disclosure,

FIG. 5a is a schematic view of an action space according to some embodiments of the present disclosure,

FIG. 5b is a schematic view of a data structure according to some embodiments of the present disclosure,

FIG. 6 is a schematic view of a neural network according to some embodiments of the present disclosure,

FIG. 7a is a schematic view of a wireless network according to some embodiments of the present disclosure,

FIG. 7b is a schematic view of an additional channel according to some embodiments of the present disclosure,

FIG. 8 is a flowchart of a method for downlink power control according to some embodiments of the present disclosure,

FIGS. 9a-b are schematic views of a data processing unit according to some embodiments of the present disclosure,

FIG. 10 is a schematic view of a data processing unit according to some embodiments of the present disclosure,

FIG. 11 is a schematic view of a computer program product according to according to some embodiments of the present disclosure,

FIG. 12 is a schematic view of a computer program product according to embodiments of the present disclosure,

FIG. 13 is a schematic illustration of a telecommunication network connected via an intermediate network to a host computer,

FIG. 14 is a generalized block diagram of a host computer communicating via a base station with a user equipment over a partially wireless connection, and

FIGS. 15-16 are flowcharts illustrating methods implemented in a communication system including a host computer, a base station and a user equipment.

### DETAILED DESCRIPTION

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially”, “approximately”, and “about” are defined as largely, but not necessarily wholly what is specified, as understood by a person of ordinary skill in the art. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises”, “has”, “includes” or “contains” one or more steps possesses those one or more steps, but is not limited to possessing only those one or more steps.

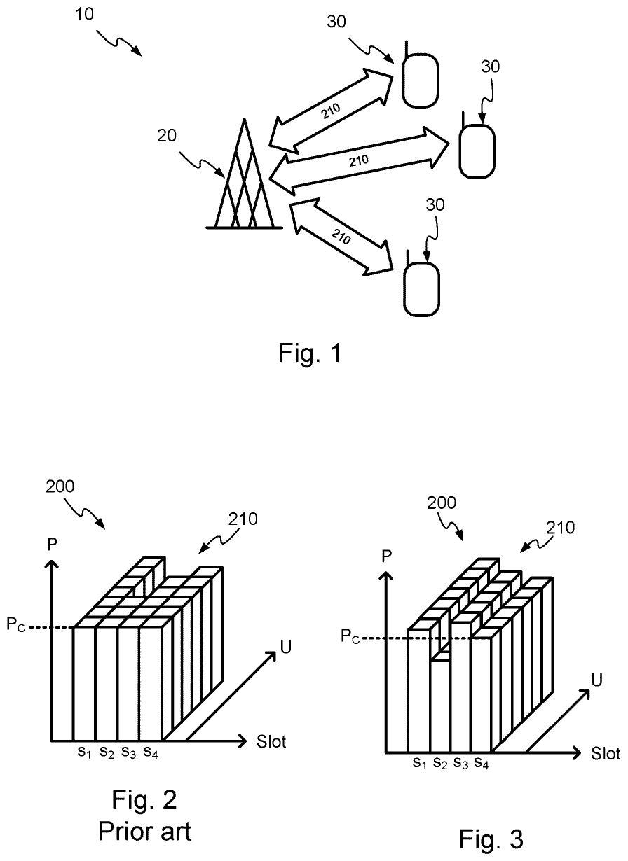

In FIG. 1, a schematic view of a wireless network 10 is shown. The wireless network 10 comprises at least one network node 20, and one or more wireless devices 30. In FIG. 1, one network node 20 is shown and three wireless devices 30, but any number of network nodes 20 and/or wireless devices 30 should be considered as part of the present disclosure. The network node 20 communicates with wireless devices 30 in communication with the network node 20 by transmitting transmissions 210 to the wireless devices 30.

With reference to FIG. 2, prior art downlink transmission power control of a shared wireless channel 200 will be explained. In FIG. 2, each rectangular block represents one transmission 210. Four slots s₁, s₂, s₃, s₄ (indicated on the horizontal axis of FIG. 2) are transmitted which, for illustrative purposes are shown having different utilization U. A first slot s₁ (the leftmost set of transmission) contains seven transmission 210, a second slot s₂ contains three transmissions 210, a third slot s₃ contains five transmission 210 and a fourth slot s₄ contains six transmissions 210. In total, in FIG. 2, 21 transmissions 210 are shown although only one reference is provided in order to simplify the figure. In the prior art, all slots s₁, s₂, s₃, s₄ on the shared wireless channel 200 are transmitted with the same common transmission power P_{C}.

With reference to FIG. 3, the conceptual result of the teachings of the present disclosure will be presented. FIG. 3 shows the shared wireless channel 200 with the same number of slots in the same order and containing the same number of transmissions 210 as that presented in FIG. 2. As a result of the teachings presented herein, the each slot s₁, s₂, s₃, s₄ will be transmitted with a common transmission power P_{C} that may be different from the common transmission power P_{C} of the one or more of the other slots s₁, s₂, s₃, s₄. As a consequence, significant power and, as the common transmission power P_{C} may be reduced, the risk of interfering with transmission from adjacent network nodes 20 is reduced. In other words, the teachings of this disclosure enables the control the common transmission power P_{C} per slot s₁, s₂, s₃, s₄, i.e. the transmissions 210 of a specific slot s₁, s₂, s₃, s₄ is still transmitted with the same common transmission power P_{C}, but the common transmission power P_{C} may change between slots s₁, s₂, s₃, s₄. It should be mentioned that there are known methods where each slot s₁, s₂, s₃, s₄ is not transmitted with a common transmission power P_{C}, but where each transmission 210 is sent using a specific transmission power. These methods put significant stress on an analog front end of the network node 20, e.g. the power amplifiers, as they are required deliver a linear response for larger peak to average rations (PAR) compared to the solution presented herein. Further, they are more complex as each transmission 210 has to handled and controlled individually and such methods cannot be utilized on transmissions that are intended for multiple recipient (broadcast transmissions).

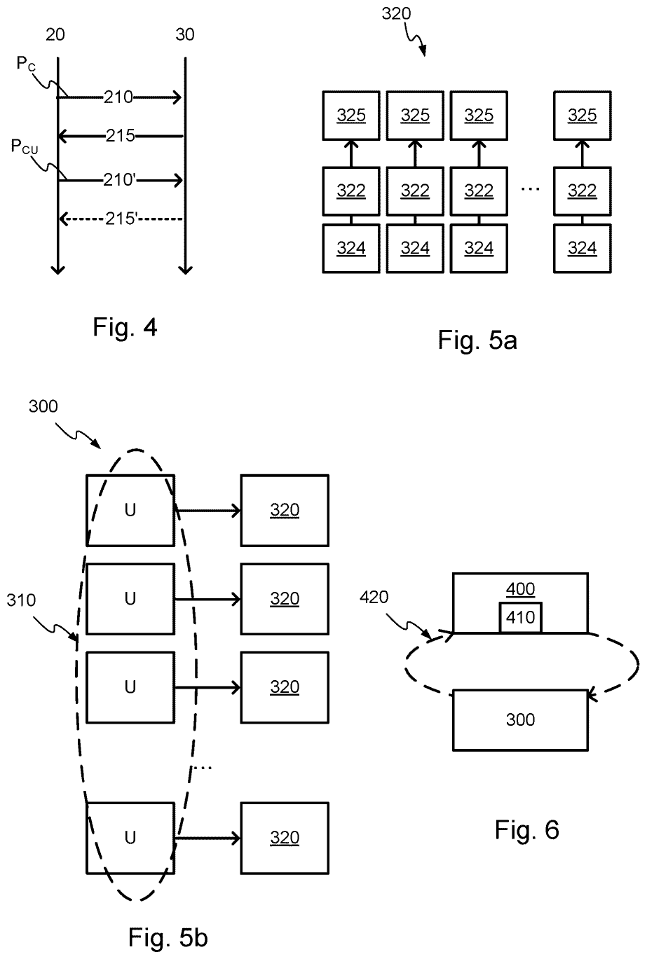

With reference to FIG. 4, a general signaling scenario between the network node 20 and the wireless device 30 will be explained. As previously explained, the network node 20 transmits transmission 210 at the common transmission power P_{C} on the shared wireless channel 200 to one or more wireless devices 30. Responsive to the transmission 210, the one or more wireless devices 30 transmits a reception indicator 215 to the network node 20. The reception indicator 215 may be any suitable indicator indicating the ability of the one or more wireless device 30 to receive the respective transmissions 210. In a preferred embodiment, the reception indicator 215 is, or is based on, a downlink Hybrid Automatic Repeat Requests (HARQ) received from the wireless devices 30. Based on the reception indicator 215, an updated common transmission power P_{CU} is determined which is used for a subsequent transmission 210′ on the shared wireless channel 200. In response to the subsequent transmission 210′, the one or more wireless devices 30 may transmit a subsequent reception indicator 215′.

The received reception indicators 215 are preferably summarized to provide a metric indicating a resulting success rate of the all the transmissions in the present slot s₁, s₂, s₃, s₄. For instance, if two wireless devices 30 are to receive transmissions 210 from the network node 20, but only one receives its transmission 210, a resulting successful rate of the two transmissions may be set to 50%. In some embodiments, the successful rate may, as mentioned, be based on reception indicators 215 obtained from the one or more wireless devices 30. In some further embodiments, the downlink HARQs are processed to provide an average of the downlink HARQs associate with a particular set of transmissions 210, e.g. a slot. This may be referred to as downlink HARQ successful rate. From here on, reference to the reception indicator 215 will be to the reference indicator 215 associated with a particular set of transmissions 210, e.g. a particular slot s₁, s₂, s₃, s₄.

The updated common transmission power P_{CU} may be determined by applying a control loop to the common transmission power P_{C}. The control loop may be configured such that the updated common transmission power P_{CU} will be increased compared to the common transmission power P_{C} if the successful rate, based on the reception indicator 215, is above a threshold. The control loop may further be configured such that the updated common transmission power P_{CU} is decreased compared to the common transmission power P_{C} if the successful rate is below the threshold. Such a control loop may be implemented with e.g. integral and/or product parts in order to optimize performance.

In some embodiments, in order to further increase the accuracy when determining the updated common transmission power P_{CU}, the utilization U of the shared wireless channel 200, in combination with the reception indicator 215, may be utilized when determining the updated common transmission power P_{CU}. This allows greater flexibility as higher utilization U generally indicate a higher risk of interference and thereby higher risk of unsuccessful reception of transmissions 210. The utilization U may be known beforehand, or as will be exemplified elsewhere, may be estimated, predicted, based on utilization U of previous transmissions 210.

With reference to FIGS. 5a-b, one optional implementation example of how to further increase the speed, accuracy and efficiency in determining the updated common transmission power P_{CU} will be explained. In FIG. 5a, an action space 320 is shown. The action space comprises a plurality of transmission quality indicators 322, 324. Each of the transmission quality indicators 322, 324 is associated with, i.e. mapped to, a transmission power indicator 325. The transmission power indicator 325 may be a relative transmission power indicator 325 indicating e.g. a dB or percentage of power in reference to a maximum transmission power of the network node 20. Alternatively, the transmission power indicator 325 may directly indicate a transmission power in e.g. dBm, PA control settings etc. However, the transmission power indicator 325 may be any suitable indicator making it possible to indicate a common transmit power P_{C}. In other words, from the transmission power indicator 325, it is possible to determine a specific common transmit power P_{C} or an updated common transmit power P_{CU}. The transmission quality indicators 322, 324 may comprise any suitable quality indicator. In a preferred embodiment, the transmission quality indicators 322, 324 comprises a Q-value 322 and an associated probability distribution 324, both associated with the transmission power indicator 325. The probability distribution 324 may be a probability distribution describing probability of a successful reception of transmissions 210 at a specific common transmit power P_{C} indicated by the transmission power indicator 325 associated with the probability distribution 324. The Q-value 322 may be interpreted as a filtered value of reward. In FIG. 5b, a data structure 300 is presented. The data structure 300 maps a utilization U to an action space 320. This may be visualized as a utilization set 310 comprising a number of different utilizations U. Preferably, the utilization set 310 covers utilization from 0% to 100% in a plurality of intervals. The intervals may be equal in size, e.g. 10 units of %, or may have different sizes, e.g. comparably smaller intervals at higher utilization U compared to intervals at lower utilization. Each utilization U is mapped to, i.e. associated with, an action space 320. The action spaces 320 define an allowable range of updated common transmission powers P_{CU} that are allowed based on the respective utilization U.

The data structure 300 presented in FIGS. 5a-b enables the selection of an updated common transmission power P_{CU} or a common transmission power P_{C} based on the utilization U and the reception indicator 215. For example, assume that the utilization U is 70% and the successful rate obtained based on received reception indicators 215 is 75%, i.e. three out of four transmissions 210 on the shared wireless channel 200 are successfully received. From this, it is possible to traverse the utilization set 310 to identify the action space 320 associated with the utilization U of 70%. Within this action space 320, a transmission quality indicators 322, 324 having a desired probability distribution 324, i.e. describing a desired likelihood of successful reception, may be identified and the power indicated by the transmission power indicator 325 may be selected as the updated common transmission power P_{CU} for later transmissions 210 on the shared wireless channel 200. Similarly, assuming that the common transmission power P_{C} is at the maximum power, the utilization U is 70% and the successful rate obtained based on received reception indicators 215 is 100%. In this exemplary scenario, it may be that in the action space 220 associated with the utilization U of 70% comprise transmission quality indicators 322, 324 that indicate substantially 100% probability at 65% of the maximum power. From this, the updated common transmission power P_{CU} for later transmissions 210 on the shared wireless channel 200 may be reduced to 65% of the maximum power without significant reduction of signaling quality or throughput.

It should be mentioned that the data structure 300 disclosed with reference to FIGS. 5a-b may advantageously be utilized in combination with the previously presented control loop, or may be implemented as a stand-alone feature. If combined with the control loop, the data structure 300 may be used to provide starting values based on utilization U and targeted transmission quality indicators 322, 324.

The data structure 300 may be provided as a predetermined data structure 300. In some embodiments, the data structure 300 is updated (or even generated) based on the common transmission power P_{C}, the utilization U and the reception indicator 215 associated with a set of transmissions 210 (i.e. a slot) on the common transmission channel 200. This may be performed similarly to when selecting the updated common transmission power P_{CU} for later transmissions 210; but rather than identifying a transmission power indicator 325 associated with the wanted quality indicator 322, 324, the quality indicators 322, 324 associated with the common transmission power P_{C} are identified and updated based on the reception indicator 215. In this manner, the reliability of the transmission quality indicators 322, 324 may be updated to increase the accuracy of the data structure 300 and thereby ensuring signaling quality at all action spaces 320.

In some embodiments, selecting of the transmission power indicator 325 of the data structure 300 may be performed by means of a neural network 400, see FIG. 6. The neural network 400 is preferably one that is based on a configurable reward function 420. The configurable reward function 420 may be configured to determine a reward based on the reception indicator 215 and a reward threshold and to train an agent 410 of the neural network 400. The reward function 420 may be configured to reward the agent (e.g. set a reward metric to 1) if the successful rate is above the reward threshold and not to reward the agent (e.g. set a reward metric to 0) if the successful rate is below the reward threshold. Each utilization U may be interpreted as a state space with an associated action space. Preferably, the agent 410 is configured to update the quality indicators 322, 324 at some, or each, interaction with the data structure 300. The agent 410 then uses the updated data structure 300 to choose an action (transmission power indicator 325) to interact with the environment (the network node 20) in next period (slot s₁, s₂, s₃, s₄).

In a specific example, assume utilization U of 93% and a common transmission power P_{C} of 80% of the maximum transmission power is used. The agent 410 is configured to update the action space 320 associated with a utilization in the range of 90-100%. If the successful rate is above the reward threshold, the reward metric is set to 1 and the Q-value 322 may be updated such that Q=Q+∝·(R−Q), where Q is the Q-value 322, R is the reward metric (e.g. 0 or 1) and α is a learning rate or filtering rate. The probability distribution 324 of the action space 320 may be updated in an ε-greedy way such that the probability of the action with the highest Q-value 322 is set to (1−ε)+ε/10 and any other actions of the action space are set to ε/10. The agent 410 may, based on the latest utilization U, extrapolate to predict the utilization U for a the next transmission 210′. The agent 410 identifies the action space 320 of the predicted utilization U and choose an action based on the corresponding probability distribution 324.

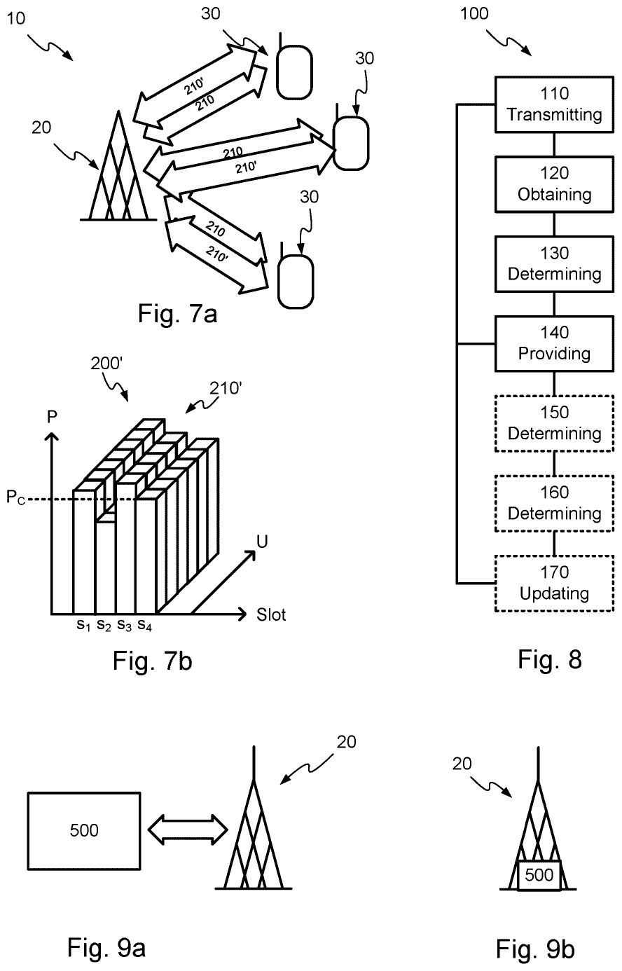

The teachings presented so far are with reference to the results of transmissions 210 on the shared wireless channel 200 being utilized for controlling the common transmission power P_{C} on that shared wireless channel 200. However, the network node 20 may be configured to transmit additional transmission 210′, see FIG. 7a to the wireless devices 30. These additional transmissions 210′ may be transmitted in parallel with, partly in parallel with, or after to the transmission 210 on the shared wireless channel 200. These additional transmissions 210′ are transmitted on an additional wireless channel 200′, FIG. 7b. The additional wireless channel 200′ may a dedicated or shared additional wireless channel 200′ and may be e.g. a data channel, a control channel etc. It should be mentioned that the teachings of this disclosure may further be applied to one or more additional wireless channels 200′. That is to say, the updated common transmitter power P_{CU} determined out of data from the shared wireless channel 200′ may be used also for the additional transmissions 210′ on the additional wireless channel(s) 200′. This is illustrated in FIG. 7b where the power used for additional transmissions 210′ on one additional channel 200′, in this embodiment a shared additional channel 200′, corresponds to the common transmitter power P_{C} as applied to the shared wireless channel 200 of FIG. 3. The additional channel 200′ of FIG. 7b is shown with a slot structure corresponding to the shared wireless channel of FIG. 3, this is for illustrative purposes only and the slot structure may very well differ between the channels 200, 200′.

Based on the teachings of the present disclosure, a method 100, see FIG. 8, of downlink transmission power control will be presented. The method 100 is preferably performed by a network node 20 which may be the network node 20 as introduced with reference to FIG. 1. The network node 20 is connected to at least one (preferably at least two) wireless devices 30. The wireless devices 30 may be the wireless devices 30 as introduced in reference to FIG. 1. The network node 20 is configured to communicate with the wireless devices 30 in a shared wireless channel 200. The shared wireless channel 200 is preferably the shared wireless channel 200 presented with reference to FIGS. 1 and 3. The method 100 may be executed once, but is preferably executed repeatedly. The method 100 is preferably repeated at a period time that corresponds to a multiple of a slot time of the wireless channel 200.

The method 100 comprises transmitting 110 transmissions 210 at the common transmission power P_{C} on the shared wireless channel 200 to each of the one or more wireless devices 30.

The method 100 further comprises obtaining 120 a reception indicator 215. The reception indicator 215 may be any reception indicator presented within the present disclosure e.g. based on the HARQs of the wireless devices 30. That is to say, reception indicator 215 is indicative of an ability of the one or more wireless devices 30 to successfully receive the respective transmissions 210.

In addition to this, the method 100 comprises determining 130 the updated common transmission power P_{CU} based on the reception indicator 215. This may be performed in accordance with any of the teachings presented herein, e.g. by utilizing the data structure 300 of FIGS. 5a-b and optionally the neural network of FIG. 6.

The method 100 also comprises providing 140 the updated common transmission power P_{CU} for use as the common transmission power P_{C} for subsequent transmissions 210′ on the shared wireless channel 200 and optionally on any additional shared wireless channels 200′. That is to say, the updated common transmission power P_{CU} is preferably used for the next transmission 210′ on the shared wireless channel 200. In some embodiments, it may not be possible or desired to update the common transmission power P_{C} in a next transmission, but rather to wait until an appropriate subsequent transmission 210′. This may be due to e.g. processing times, hardware limitations, regulatory limitations etc.

Optionally, in embodiments comprising the data structure 300, the method 100 may comprise, as detailed elsewhere, updating the data structure 300 based on the result of the transmission 210. To this end, the method 100 comprises determining 150 the action space 320 associated with the utilization U of the shared wireless channel 200 and determining 160 the transmission quality indicator 322, 324 associated with the transmission power indicator 325 of the determined action space 320 matching the common transmission power P_{C}. Further to this, the method 100 comprises updating 170 the determined transmission quality indicator 322, 324 based on the obtained reception indicator 215. These steps 150, 160, 170 are preferably performed each time an updated common transmission power P_{CU} is determined 130, but may, e.g. to save energy, processing power etc., be performed at other intervals than the determining of the updated common transmission power P_{CU}.

In FIGS. 9a-b, a data processing unit 500 is presented. The data processing unit 500 may be configured to be operatively connected to the network node 20, FIG. 9a, or configured to be comprised in the network node 20, FIG. 9b. The network node 20 may be the network node 20 as introduced in reference to FIG. 1. The network node 20 is connected to at least one (preferably at least two) wireless devices 30. The wireless devices 30 may be the wireless devices 30 as introduced in reference to FIG. 1. The network node 20 is configured to communicate with the wireless devices 30 in a shared wireless channel 200. The shared wireless channel 200 is preferably the shared wireless channel 200 presented with reference to FIGS. 1 and 3. The data processing unit 500 may be configured to cause execution of the following features once, but is preferably configured to cause execution of the following features repeatedly. The data processing unit 500 may be configured repeatedly to cause execution of the following features, preferably at period time that corresponds to a multiple of a slot time of the wireless channel 200.

The data processing unit 500 is configured to cause the transmitting of transmissions 210 at the common transmission power P_{C} on the shared wireless channel 200 to each of the one or more wireless devices 30.

The data processing unit 500 further configured to cause obtaining of the reception indicator 215. The reception indicator 215 may be any reception indicator presented within the present disclosure e.g. based on the HARQs of the wireless devices 30. That is to say, reception indicator 215 is indicative of an ability of the one or more wireless devices 30 to successfully receive the respective transmissions 210.

In addition to this, the data processing unit 500 is configured to cause determining of the updated common transmission power P_{CU} based on the reception indicator 215. This may be performed in accordance with any of the teachings presented herein, e.g. by utilizing the data structure 300 of FIGS. 5a-b and optionally the neural network of FIG. 6.

The data processing unit 500 is also configured to cause provisioning of the updated common transmission power P_{CU} for use as the common transmission power P_{C} for subsequent transmissions 210 on the shared wireless channel 200 and optionally on any additional shared wireless channels 200′. That is to say, the updated common transmission power P_{CU} is preferably used for the next transmission 210 on the shared wireless channel 200, but in some embodiments, it may not be possible, or desired, to update the common transmission power P_{C} in a next transmission but rather wait until an appropriate subsequent transmission. This may be due to e.g. processing times, hardware limitations, regulatory limitations etc.

Optionally, in embodiments comprising the data structure 300, the data processing unit 500 may be configured to cause, as detailed elsewhere, updating of the data structure 300 based on the result of the transmission 210. To this end, the data processing unit 500 may be configured to cause determining of the action space 320 associated with the utilization U of the shared wireless channel 200 and determining of the transmission quality indicator 322, 324 associated with the transmission power indicator 325 of the determined action space 320 matching the common transmission power P_{C}. Further to this, the data processing unit 500 may be configured to cause updating of the determined transmission quality indicator 322, 324 based on the obtained reception indicator 215. These steps 150, 160, 170 are preferably performed each time an updated common transmission power P_{CU} is determined 130, but may, e.g. to save energy, processing power etc., be performed at other intervals than the determining of the updated common transmission power P_{CU}.

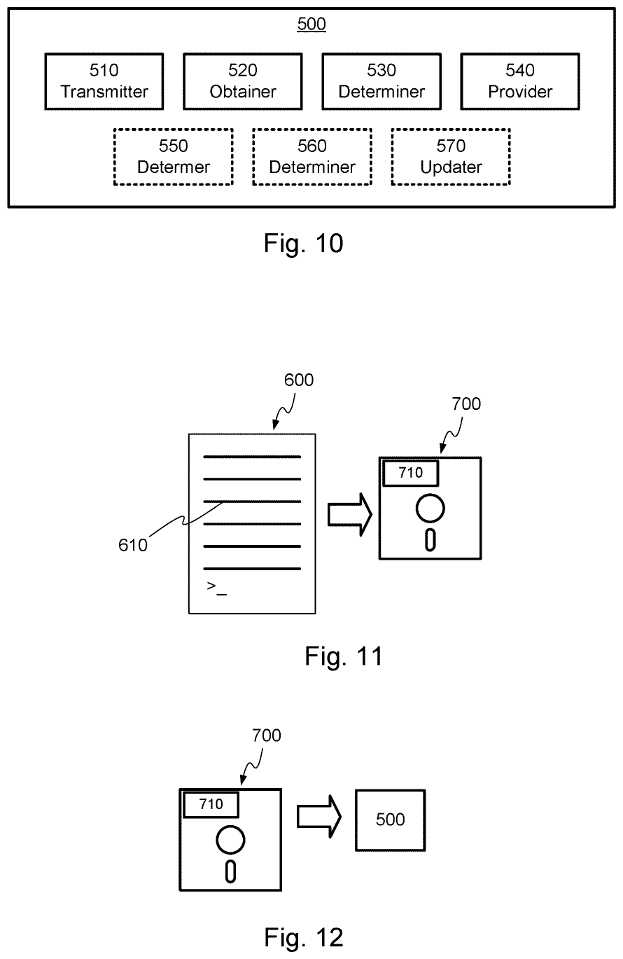

In some embodiments, the data processing unit 500 is configured to cause the execution of the method 100 introduced with reference to FIG. 8. In some embodiments, see FIG. 10, the data processing unit 500 may comprise a transmitter 510, configured to cause or perform the transmitting 110 of transmissions 210 as described in reference to FIG. 8. The data processing unit 500 may further comprise an obtainer 520 configured to cause or perform obtaining 120 of the reception indicator 215 as described in reference to FIG. 8. The data processing unit 500 may further comprise a determiner 530 configured to cause or perform the determining 130 of an updated common transmission power P_{CU} as described in reference to FIG. 8. The data processing unit 500 may further comprise a provider 540 configured to cause or perform the provisioning 140 the updated common transmission power P_{CU} as described in reference to FIG. 8. The data processing unit 500 may further comprise a determiner 550 configured to cause or perform the determining 150 of the action space 320 as described in reference to FIG. 8. The data processing unit 500 may further comprise a determiner 560 configured to cause or perform the determining 160 the transmission quality indicator 322 as described in reference to FIG. 8. The data processing unit 500 may further comprise an updated 570 configured to cause or perform the updating 170 the determined transmission quality indicator 322, 324 as described in reference to FIG. 8.

In FIG. 11, a computer program 600 is shown. The computer program 600 comprises program instructions 610. These program instructions 610, when executed, are configured to cause the execution of the method 100 as described with reference to FIG. 8. The computer program 600 may be stored onto a non-transitory computer readable medium 710 forming part of a computer program product 700 (illustrated as a vintage floppy drive in FIG. 11). As seen in FIG. 12 the computer program 600 is loadable into the data processing unit 500 such that, when executed by the data processing unit 500, the data processing unit 500 cause the execution of the method 100 of downlink transmission power control performed as described with reference to FIG. 8.

Simulation results of the teachings presented herein have yielded that, in a comparably high-load situation, the table-based learning method as explained in reference to FIGS. 5a-b and 6, can significantly reduce power consumption with little or no sacrifice in throughput, i.e. 40-45% PDxCH power reduction with only 4-5% throughput degradation. In situations with a comparably low load, the teachings does not adversely affect the throughput. For the learning method as detailed with reference to FIG. 6, simulations has proven this to be a stable and straight forward implementation wherein a few percentage change of a solution hyper-parameter (e.g. the reward threshold) shows a neglectable performance difference (e.g. <1%) across all simulated network loads. An obvious trade-off may be made throughput and power consumption as a higher reward threshold (i.e. more rigorous reward definition) will reduce throughput degradation but increase PDxCH power consumption. The settings used for the simulations are summarized in Table 1 below.

TABLE 1
Simulation settings

| Major parameter | Setting | |
|---|---|---|
| Nr of cells | 7 × 3 | |
| maximumDownlinkPower | 36 | W |
| Cell radius | 166.667 | m |
| Nr of PRB per cell | 100 | |
| carrierFrequency | 3.5 | GHz |
| Numerology | 1 | |
| TDD config | {DL, DL, DL, UL} | |
| losProbabilityFunction | SCM | |
| UE speed | 0.833 | m/s |
| Simulation duration | 60.5 | s |

| | |
|---|---|
| EnE solution learning period | 0.02 s (i.e. 3000 learning |
| | instances per sim) |

The results of simulations with different configurations of the network node 20, number of users and reward thresholds are summarized in Table 2 below. The results are compared to a baseline, i.e. same settings, but without the power control as presented herein.

TABLE 2
Simulation results

| | Performance comparison @ Relative Intensity = 1.0: present | | | | | |
|---|---|---|---|---|---|---|
| | solution w.r.t baseline | | | | | |
| | 63 DL-FTP-10MB | | 126 DL-FTP-1MB | | 126 DL-FTP-15MB | |
| | users | | users | | users | |
| | reward | reward | reward | reward | reward | reward |
| | threshold | threshold | threshold | threshold | threshold | threshold |
| Performance Metrics | 98% | 94% | 98% | 94% | 98% | 94% |
| Avg. Cell Throughput | −4.65% | −4.94% | −4.25% | −4.40% | −4.31% | −4.46% |
| Avg. PDSCH HARQ BLER | 0.1435% | 0.1452% | 0.1614% | 0.1611% | 0.1106% | 0.1092% |
| (absolute diff. between | | | | | | |
| present solution and | | | | | | |
| baseline) | | | | | | |
| Avg. UE perceived SINR | −4.48% | −4.70% | −5.43% | −5.46% | −4.34% | −4.42% |
| Total PDSCH power | −42.86% | −43.76% | −45.11% | −44.62% | −43.34% | −43.39% |
| Total PDCCH power | −41.19% | −42.13% | −42.99% | −43.55% | −42.15% | −42.22% |

From the simulation results, it is clear that the teachings of the present disclosure provide a significant reduction in power consumption, more than 40% for all simulation scenarios, with only a slight decrease in average cell throughput and a slight increase in Block Error Rate (BLER).

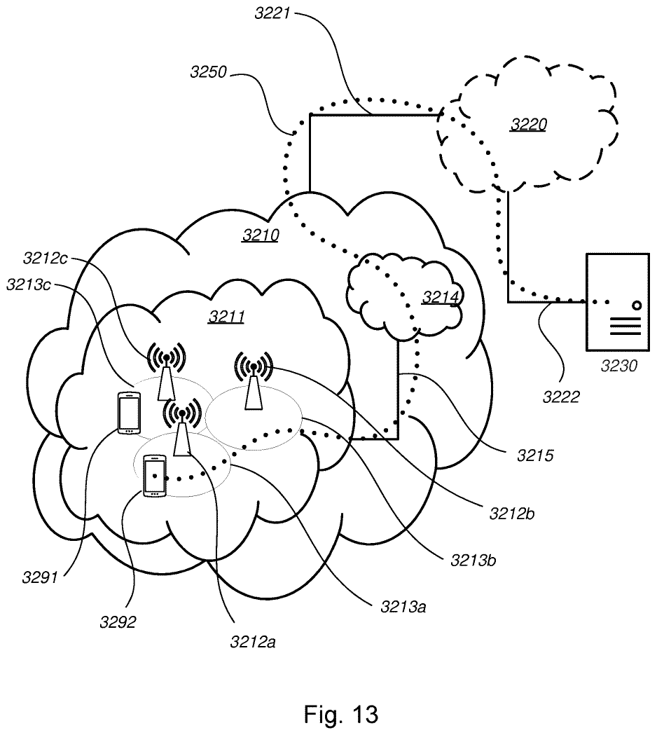

With reference to FIG. 13, in accordance with an embodiment, communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 13 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

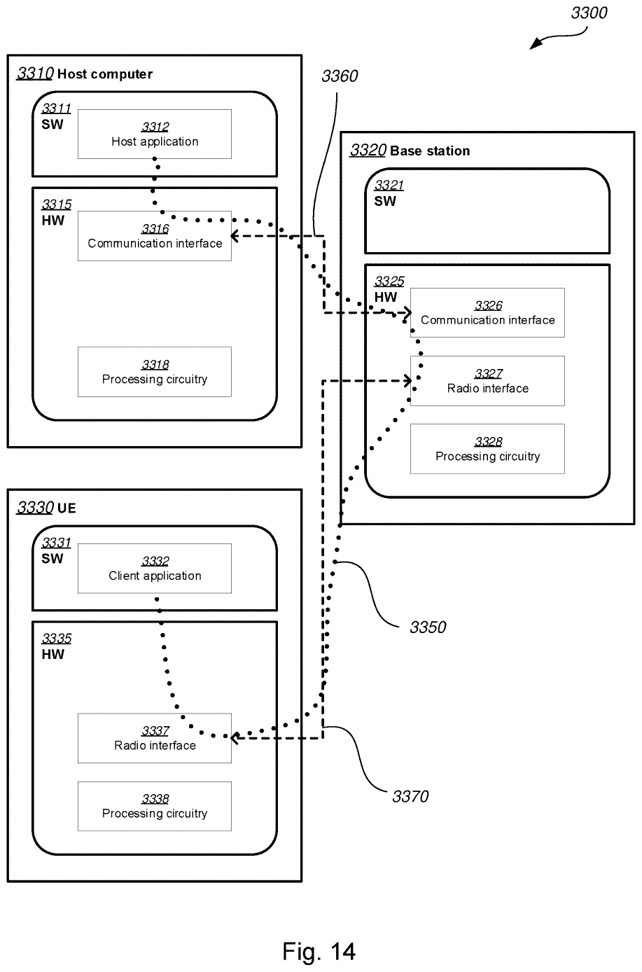

Example implementations, in accordance with an embodiment, of the UE, base station and host computer discussed in the preceding paragraphs will now be described with reference to FIG. 14. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 14) served by the base station 3320. The communication interface 3326 may be configured to facilitate a connection 3360 to the host computer 3310. The connection 3360 may be direct or it may pass through a core network (not shown in FIG. 14) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 14 may be identical to the host computer 3230, one of the base stations 3212a, 3212b, 3212c and one of the UEs 3291, 3292 of FIG. 13, respectively. This is to say, the inner workings of these entities may be as shown in FIG. 14 and independently, the surrounding network topology may be that of FIG. 13.

In FIG. 14, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the [select the applicable RAN effect: data rate, latency, power consumption] and thereby provide benefits such as [select the applicable corresponding effect on the OTT service: reduced user waiting time, relaxed restriction on file size, better responsiveness, extended battery lifetime].

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

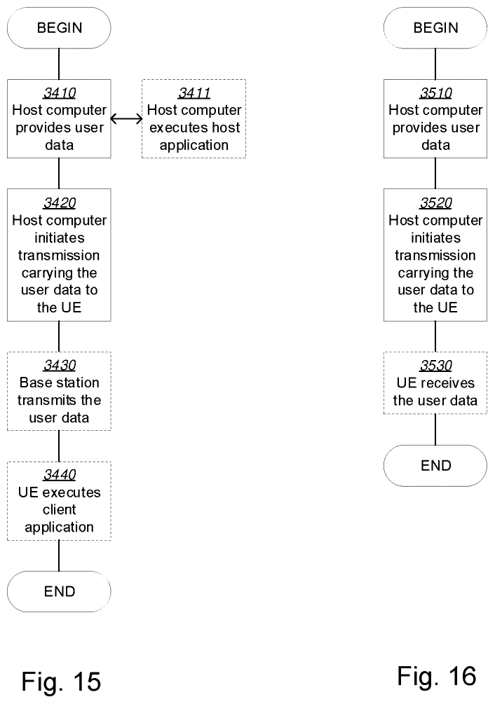

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference to downlink power control in a cellular network, persons skilled in the art will appreciate that the embodiments of the invention can equivalently be applied to any other network where power control is desired. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

### Numbered Embodiments

1. A base station configured to communicate with a user equipment (UE), the base station comprising a radio interface and processing circuitry configured to control a downlink transmission power of the base station by repeatedly causing:
transmitting of transmissions at a common transmission power on a shared wireless channel to the UE;
obtaining of a reception indicator indicative of an ability of the UE to successfully receive the respective transmissions;
determining of an updated common transmission power based on the reception indicator; and
provisioning of the updated common transmission power for use as the common transmission power for subsequent transmissions on the shared wireless channel.

5. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to control a downlink transmission power of the base station by repeatedly causing:
transmitting of transmissions at a common transmission power on a shared wireless channel to the UE;
obtaining of a reception indicator indicative of an ability of the UE to successfully receive the respective transmissions;
determining of an updated common transmission power based on the reception indicator; and
provisioning of the updated common transmission power for use as the common transmission power for subsequent transmissions on the shared wireless channel.

6. The communication system of embodiment 5, further including the base station.

7. The communication system of embodiment 6, further including the UE, wherein the UE is configured to communicate with the base station.

8. The communication system of embodiment 7, wherein:
the processing circuitry of the host computer is configured to execute a host application, thereby providing the user data; and
the UE comprises processing circuitry configured to execute a client application associated with the host application.

11. A method implemented in a base station to a downlink transmission power of the base station by repeatedly:
transmitting of transmissions at a common transmission power on a shared wireless channel to a UE in communication with the base station;
obtaining of a reception indicator indicative of an ability of the UE to successfully receive the respective transmissions;
determining of an updated common transmission power based on the reception indicator; and
provisioning of the updated common transmission power for use as the common transmission power for subsequent transmissions on the shared wireless channel.

15. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station is configured control a downlink transmission power of the base station by repeatedly:
transmitting of transmissions at a common transmission power on a shared wireless channel to each of the UE;
obtaining of a reception indicator indicative of an ability of the UE to successfully receive the respective transmissions;
determining of an updated common transmission power based on the reception indicator; and
provisioning of the updated common transmission power for use as the common transmission power for subsequent transmissions on the shared wireless channel.

16. The method of embodiment 15, further comprising:
at the base station, transmitting the user data.

17. The method of embodiment 16, wherein the user data is provided at the host computer by executing a host application, the method further comprising:
at the UE, executing a client application associated with the host application.

1. A method of downlink transmission power control performed by a network node in communication with two or more wireless devices, the method comprising, repeatedly:
transmitting transmissions at a common transmission power, P_{C}, on a shared wireless channel to each of the two or more wireless devices;
obtaining a reception indicator indicative of an ability of the two or more wireless devices to successfully receive the respective transmissions;
determining an updated common transmission power, P_{CU}, based on the reception indicator; and
providing the P_{CU} for use as a common transmission power, P_{C}, for subsequent transmissions on the shared wireless channel.

2. The method of claim 1, wherein determining the P_{CU} is further based on a utilization, U, of the shared wireless channel.

3. The method of claim 2, wherein determining the P_{CU} is further based on a data structure mapping the U of the shared wireless channel to an action space comprising a plurality of transmission quality indicators, each of the plurality of transmission quality indicators is associated with a transmission power indicator.

4. The method of claim 3, wherein the transmission quality indicators of the data structure each comprise a Q-value and an associated probability, both associated with the respective transmission power indicator.

5. The method of claim 3, further comprising: determining the action space associated with the U of the shared wireless channel;
determining the transmission quality indicator of the plurality of transmission quality indicators associated with the transmission power indicator of the determined action space matching the P_{C}; and
updating the determined transmission quality indicator based on the obtained reception indicator.

6. The method of claim 3, wherein determining the P_{CU} is performed by a neural network.

7. The method of claim 6, wherein the neural network is based on a configurable reward function configured to determine a reward based on the reception indicator and a reward threshold.

8. (canceled)

9. The method of claim 1, wherein the reception indicator is based on Hybrid Automatic Repeat Requests, HARQs, obtained from the two or more wireless devices.

10. The method of claim 1, wherein providing the P_{CU} further comprises providing the P_{CU} for use as the P_{C} for transmissions on one or more additional wireless channels.

11. The method of claim 1, repeated at a period time that is a multiple of a slot period of the shared wireless channel.

12. (canceled)

13. A data processing unit, configured to be operatively connected to a network node in communication with two or more wireless devices and configured to control a downlink transmission power of the network node by repeatedly causing:
transmitting of transmissions at a common transmission power, P_{C}, on a shared wireless channel to each of the two or more wireless devices;
obtaining of a reception indicator indicative of an ability of the two or more wireless devices to successfully receive the respective transmissions;
determining of an updated common transmission power, P_{CU}, based on the reception indicator; and
provisioning of the P_{CU} for use as the P_{C} for subsequent transmissions on the shared wireless channel.

14. The data processing unit of claim 13, wherein causing the determining of the P_{CU} is further based on a utilization, U, of the shared wireless channel.

15. The data processing unit of claim 14, wherein causing the determining of the P_{CU} is further based on a data structure mapping the U of the shared wireless channel to an action space comprising a plurality of transmission quality indicators, each of the plurality of transmission quality indicators is associated with a transmission power indicator.

16. The data processing unit of claim 15, wherein the transmission quality indicators of the data structure each comprise a Q-value and an associated probability, both associated with the respective transmission power indicator.

17. The data processing unit of claim 15, further configured to control the downlink transmission power of the network node by repeatedly causing:
determining of the action space associated with the U of the shared wireless channel;
determining of the transmission quality indicator of the plurality of transmission quality indicators associated with the transmission power indicator of the determined action space matching the P_{C} on the shared wireless channel; and
updating of the determined transmission quality indicator based on the obtained reception indicator.

18. The data processing unit of claim 15, wherein the determining of the P_{CU} is performed by a neural network.

19-20. (canceled)

21. The data processing unit of claim 13, wherein the reception indicator is based on Hybrid Automatic Repeat Requests, HARQs, obtained from the two or more wireless devices.

22. The data processing unit of claim 13, wherein causing the provisioning of the P_{CU} further comprises causing provisioning of the P_{CU} for use as the P_{C} for transmissions on one or more additional wireless channels.

23. The data processing unit of claim 13, further configured to control the downlink transmission power of the network node by repeating at a period time that is a multiple of a slot period of the shared wireless channel.

24-28. (canceled)

29. A computer program product comprising a non-transitory computer readable medium, having thereon a computer program comprising program instructions, the computer program being loadable into a data processing unit and configured to cause execution of the method according to claim 1 when the computer program is run by the data processing unit.
